(19) United States
(12) Patent Application Publication
(10) Pub. No.: US 2015/0312059 A1
(43) Pub. Date: Oct. 29, 2015

(54) COMPENSATING CIRCUIT, INFORMATION PROCESSING APPARATUS, COMPENSATION METHOD, AND COMPUTER READABLE STORAGE MEDIUM

(71) Applicant: ADVANTEST CORPORATION, Tokyo (JP)

(72) Inventor: Takashi KATO, Saitama (JP)

(21) Appl. No.: 14/677,992

(22) Filed: Apr. 3, 2015

(30) Foreign Application Priority Data
Apr. 23, 2014 (JP) 2014-089169

(51) Int. Cl. H04L 25/02; H04B 1/04

(52) U.S. Cl. CPC H04L 25/0278; H04B 1/0475

(57) ABSTRACT

To compensate for degradation of a waveform based on a high frequency attenuation characteristic of a transmission path with a simple configuration. A compensating circuit, a compensating method, and a computer readable storage medium are provided for compensating for loss of a transmission signal that is connected to a transmission path and transmitted through the transmission path, the compensating circuit comprising: a plurality of transition points at which characteristic impedance is varied, wherein the compensating circuit shapes a waveform of the transmission signal by superimposing, on the transmission signal, a plurality of reflected waves that are generated by the plurality of transition points and have mutually different transmission time.

The contents of the following Japanese patent application(s) are incorporated herein by reference: No. 2014-089169 filed in JP on Apr. 23, 2014.

### BACKGROUND

1. Technical Field

The present invention relates to a compensating circuit, an information processing apparatus, a compensation method, and a computer readable storage medium.

2. Related Art

Conventionally, it has been known that degradation of a waveform based on a high frequency attenuation characteristic of a transmission path is compensated for by adding, to the transmission path, a resistive element, a capacitance element, an inductor element, and/or a transmission line or the like that is equivalent with these elements (for example, see Patent Literature).

[Patent Literature 1] Japanese Patent Application Publication No. 2006-254303

However, when degradation of a waveform is compensated for by adding a circuit element or the like, correction of the waveform cannot be performed sufficiently if the attenuation characteristic of the transmission path is complex. The present invention provides correction that can cope with a waveform that is degraded in a complex manner, with addition of fewer parts and at lower costs.

### SUMMARY

Therefore, it is an object of an aspect of the innovations herein to provide a compensating circuit, an information processing apparatus, a compensation method, and a computer readable storage medium, which are capable of overcoming the above drawbacks accompanying the related art. The above and other objects can be achieved by combinations described in the claims. A first aspect of the present invention provides a compensating circuit, a compensating method, and a computer readable storage medium for compensating for loss of a transmission signal that is connected to a transmission path and transmitted through the transmission path, the compensating circuit comprising: a plurality of transition points at which characteristic impedance is varied, wherein the compensating circuit shapes a waveform of the transmission signal by superimposing, on the transmission signal, a plurality of reflected waves that are generated by the plurality of transition points and have mutually different transmission time.

A second aspect of the present invention provides a compensating circuit, an information processing apparatus, and a computer readable storage medium for compensating for loss of a transmission signal that is connected to a transmission path and transmitted through the transmission path, the compensating circuit comprising: at least one transition point at which characteristic impedance is varied, wherein the compensating circuit compensates for loss of the transmission signal by superimposing a reflected wave generated at the transition point on the transmission signal.

A third aspect of the present invention provides an information processing apparatus that calculates a reflection characteristic that the compensating circuit according to the first or second aspect of the present invention should have, the information processing apparatus comprising: a generating section that generates a compensation waveform to compensate for loss due to the transmission path; and a calculation section that calculates the reflection characteristic to approximate the compensation waveform by the reflected wave.

The summary clause does not necessarily describe all necessary features of the embodiments of the present invention. The present invention may also be a sub-combination of the features described above.

### BRIEF DESCRIPTION OF THE DRAWINGS

FIG. 1 illustrates a first configuration example of a compensating circuit 100 according to the present embodiment, together with a transmitting section 10, a transmission path 20, and a receiving circuit 30.

FIG. 2 illustrates a configuration example of an information processing apparatus 200 according to the present embodiment.

FIG. 3 illustrates an operation flow of the information processing apparatus 200 according to the present embodiment.

FIG. 4 illustrates one example of an attenuation characteristic of a transmission path 20 according to the present embodiment.

FIG. 5 illustrates one example of the inverse characteristic that corresponds to the attenuation characteristic of the transmission path 20 according to the present embodiment.

FIG. 6 illustrates one example of a compensation waveform that corresponds to the inverse characteristic of the attenuation characteristic illustrated in FIG. 5.

FIG. 7 illustrates one example of a waveform compensated by the compensating circuit 100 according to the present embodiment.

FIG. 8 illustrates a second configuration example of the compensating circuit 100 according to the present embodiment.

FIG. 9 illustrates a third configuration example of the compensating circuit 100 according to the present embodiment.

FIG. 10 illustrates a fourth configuration example of the compensating circuit 100 according to the present embodiment.

FIG. 11 illustrates a variant of the compensating circuit 100 according to the present embodiment.

FIG. 12 illustrates one example of a hardware configuration of a computer 1900 that functions as the information processing apparatus 200 according to the present embodiment.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

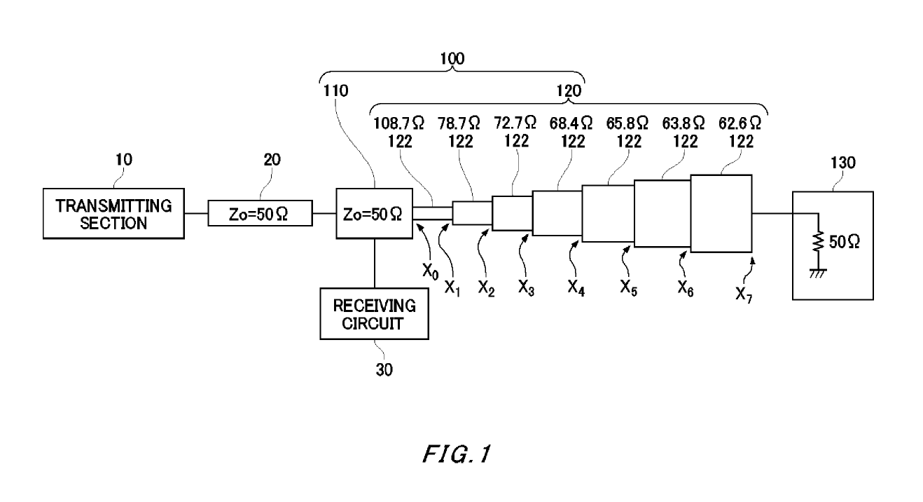

FIG. 1 illustrates a first configuration example of a compensating circuit 100 according to the present embodiment, together with a transmitting section 10, a transmission path 20, and a receiving circuit 30. The transmitting section 10 generates an electrical signal to be transmitted, and transmits it to the receiving circuit 30 via the transmission path 20. The transmitting section 10 is, in one example, a test apparatus that generates a test signal, and transmits it to a device under test.

The transmission path 20 is provided between the transmitting section 10 and the receiving circuit 30, and transmits an electrical signal generated by the transmitting section 10 to the receiving circuit 30. The transmitting section 10 and the receiving circuit 30 are connected to a transmission terminal at one end and a receiving terminal at the other end of the transmission path 20, respectively. The transmission path 20 includes, for example, a strip line, a micro strip line, a slot line, and/or coplanar waveguide, and the like. The transmission path 20 has the frequency characteristic for an electrical signal to be transmitted, according to the line length, the line width, the line shape, the distance between the line and a ground electrode, a dielectric material between the line and the ground electrode, the shape of the ground electrode, and the like.

The transmission path 20 has, for example, the frequency characteristic that shows attenuation of several dBs or higher in a high frequency domain of about several hundred MHz to about several GHz or higher. Thereby, the transmission path 20 generates distortion in the waveform of an electrical signal transmitted by the transmitting section 10, for example, degrades a rising waveform and a falling waveform so that they become blunt, and transmits the electrical signal to the receiving circuit 30.

The receiving circuit 30 receives, via the transmission path 20, an electrical signal transmitted by the transmitting section 10. The receiving circuit 30 is, for example, a device under test such as an analog circuit, a digital circuit, a memory, a system-on-a-chip (SOC), or the like, and receives a test signal from a test apparatus. In this case, the test apparatus may input, to the device under test, a test signal based on a test pattern for testing the device under test, and judge the quality of the device under test based on an output signal output by the device under test responding to the test signal.

Here, if an electrical signal transmitted by the transmitting section 10 includes a high-frequency component of about several hundred MHz to several GHz or higher, the transmission path 20 degrades the signal waveform as described above, and transmits it to the receiving circuit 30. Then, the compensating circuit 100 is connected to the transmission path 20, and compensates for the waveform distortion (loss) of a transmission signal by superimposing a reflected wave on the transmission signal transmitted from the transmitting section 10 through the transmission path 20.

The compensating circuit 100 comprises at least one transition point at which characteristic impedance is varied, and compensates for transmission loss of a transmission signal by superimposing a reflected wave generated at the transition point on the transmission signal. The compensating circuit 100 is connected to the receiving terminal side of the transmission path 20, and superimposes, on a transmission signal transmitted from the transmission terminal to the receiving terminal of the transmission path 20, a reflected wave that is reflected by a transition point after passing through the receiving terminal, and is transmitted to the receiving terminal. In the present example, an example in which the compensating circuit 100 comprises a plurality of transition points at which characteristic impedance is varied is explained.

The compensating circuit 100 is connected to the receiving terminal side of the transmission path 20, and superimposes, on a the transmission signal transmitted from the transmission terminal to the receiving terminal of the transmission path 20, a plurality of reflected waves that are reflected by mutually different transition points among the plurality of transition points after passing through the receiving terminal, and are transmitted to the receiving terminal. The compensating circuit 100 comprises the transition point at each end of a plurality of sections with a predetermined length.

The compensating circuit 100 comprises an input/output section 110 and a transmission path 120. The input/output section 110 is connected to the transmission path 20, and receives a transmission signal transmitted from the transmitting section 10. Also, the input/output section 110 is connected to the receiving circuit 30, and supplies a compensated transmission signal to the receiving circuit 30. The impedance of the input/output section 110 desirably matches those of the transmission path 20 and the receiving circuit 30, and the input/output section 110 has, in one example, characteristic impedance of 50Ω.

One end of the transmission path 120 is connected to the input/output section 110, and the other end thereof is terminated by being connected to the terminating resistance 130. The impedance of the terminating resistance 130 desirably matches that of the transmission path 120. The terminating resistance 130 has, in one example, characteristic impedance of 50Ω. The transmission path 120 allows a reflected wave generated at a characteristic impedance transition point therein to be transmitted to one end side of the transmission path 120, while transmitting a part of an electrical signal transmitted from the transmitting section 10 to the transmission path 20 from the one end to the other end side of the transmission path 120.

Thereby, the transmission path 120 superimposes a reflected wave generated at a characteristic impedance transition point on an electrical signal transmitted from transmission path 20 to the receiving circuit 30, and inputs the superimpose electrical signal to the receiving circuit 30. The transmission path 120 generates, as a reflected wave, an electrical signal to compensate a signal which is degraded by the transmission path 20, and the receiving circuit 30 receives a compensated electrical signal. The transmission path 120 has a plurality of short transmission paths 122 as characteristic impedance transition points therein.

Each short transmission path among the short transmission paths 122 has predetermined characteristic impedance. The plurality of short transmission paths 122 are mutually connected electrically, and form the transmission path 120. FIG. 1 shows an example in which the transmission path 120 has the plurality of short transmission paths 122 having a predetermined shape, and a characteristic impedance transition point Xₙ(n=0, 1, 2, . . . ) is formed between adjacent short transmission paths 122

In this manner, the compensating circuit 100 has the plurality of short transmission paths 122 to be a plurality of sections of the transmission path 120, and has a transition point Xₙ at one end and the other end of each short transmission path.

The plurality of short transmission paths 122 includes, for example, a strip line, a micro strip line, a slot line, and/or a coplanar waveguide, or the like. FIG. 1 is for explaining an example in which the plurality of short transmission paths 122 is formed with strip lines. Each short transmission path among the plurality of short transmission paths 122 has predetermined characteristic impedance. For example, each short transmission path 122 has a line width according to its characteristic impedance.

Instead of or in addition to this, each short transmission path 122 may have the distance from a ground electrode, a dielectric material between the transmission path and the ground electrode, and/or the shape of the ground electrode, or the like according to the characteristic impedance. In the present example, an example in which the transmission path 120 is formed with a multilayer substrate having approximately constant predetermined values of the distance between the transmission path 120 and the ground electrode, and the dielectric constant of a dielectric material between the transmission path 120 and the ground electrode is explained. Here, the ground electrode may be formed to cover the transmission path 120 via the dielectric material on the upper surface side and the lower surface side of the transmission path 120.

In other words, the compensating circuit 100 in the present example has, at each short distance transmission path among the plurality of short transmission paths 122 that are a plurality of sections, a line width according to the corresponding characteristic impedance. Thereby, in the transmission path 120, characteristic impedance transition points Xₙ are formed between adjacent short transmission paths 122, and reflected waves are generated at the transition points. Here, a reflected wave generated at each transition point is respectively generated according to the amplitude of a transmission signal input to the transition point, and the variation in characteristic impedance.

Also, each short transmission path 122 has a predetermined transmission path length. In other words, a plurality of reflected waves that are generated by the plurality of transition points Xₙ, and have mutually different transmission time is superimposed on a transmission signal transmitted from the transmitting section 10 via the transmission path 20 to shape the waveform of the transmission signal.

In the present example, each short transmission path 122 has a transmission path length that corresponds to an electrical length of 25 ps. In other words, the characteristic impedance transition points Xₙ are formed every electrical length of 25 ps in the direction from one end to the other end in the transmission path 120. Thereby, for example, respective reflected waves generated at transition points X₀, X₁, X₂, and X₃ reach the transition point X₀ at 0, 50, 100, and 150 [ps] with reference to the time at which the transmission signal has passed the transition point X₀ (at time 0), and are to be superimposed on the electrical signal transmitted from the transmission path 20 to the receiving circuit 30.

In this manner, even if the transmission waveform is distorted due to attenuation of a high-frequency component, the compensating circuit 100 can compensate the distorted transmission waveform by allowing high-frequency components that reach the receiving circuit 30 at different times to be reflected (in other words, to be delayed in time), and superimposing them. In other words, the reflection characteristic of the compensating circuit 100 is determined and the characteristic impedance (in other words, line lengths) of the plurality of short transmission paths 122 is designed so as to compensate a transmission waveform according to the frequency characteristic of the transmission path 20 connected between the transmitting section 10 and the receiving circuit 30. In this manner, the characteristic impedance of the short transmission paths 122 is determined by the reflection characteristic that the compensating circuit 100 should have, and is calculated by the information processing apparatus 200 according to the present embodiment.

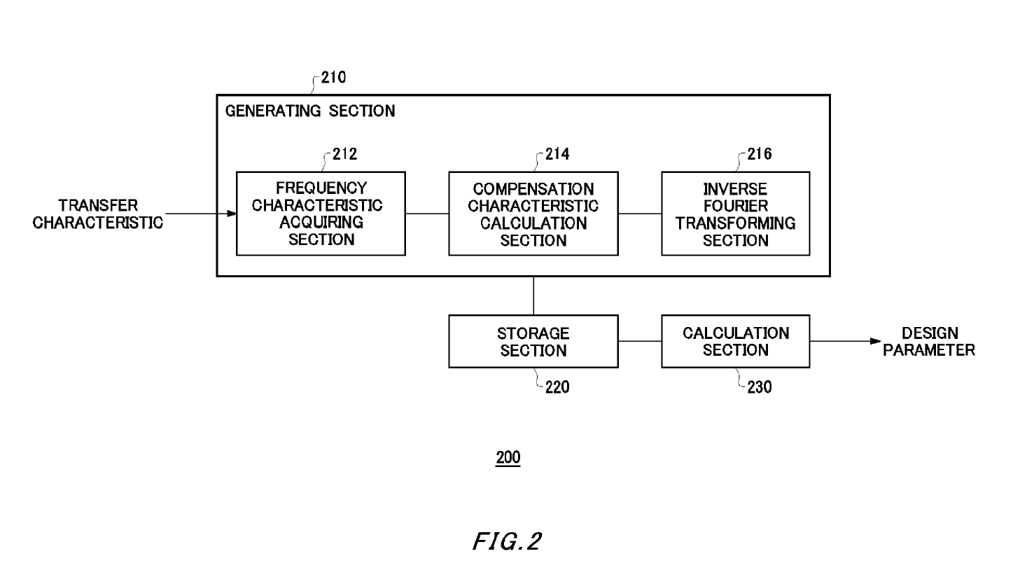

FIG. 2 illustrates a configuration example of the information processing apparatus 200 according to the present embodiment. The information processing apparatus 200 calculates the reflection characteristic that the compensating circuit 100 should have. The information processing apparatus 200 comprises a generating section 210, a storage section 220, and a calculation section 230.

The generating section 210 generates a compensation waveform to compensate for loss due to the transmission path 20. The generating section 210 has a frequency characteristic acquiring section 212, a compensation characteristic calculation section 214, and an inverse Fourier transforming section 216.

The frequency characteristic acquiring section 212 acquires the transfer characteristic of the transmission path 20 in the frequency domain. In other words, the frequency characteristic acquiring section 212 acquires the frequency characteristic of the transmission loss of the transmission path 20. The frequency characteristic acquiring section 212 may acquire data about transmission loss stored in a predetermined format. The frequency characteristic acquiring section 212 may be connected to a network or the like, and acquire data about transmission loss via the network. The frequency characteristic acquiring section 212 may acquire data about transmission loss transmitted through wire or wirelessly by receiving it.

The frequency characteristic acquiring section 212 may acquire data about transmission loss from an output result of software or the like, such as a simulator, that calculates circuit characteristics. Also, the frequency characteristic acquiring section 212 may acquire a result obtained by measurement of the transfer characteristic of the transmission path 20 performed by an apparatus, such as a network analyzer, that measures transfer characteristics of a circuit. Also, the frequency characteristic acquiring section 212 may acquire data about transmission loss from data input by a user through an input device such as a keyboard. The frequency characteristic acquiring section 212 may store acquired data about transmission loss in the storage section 220.

The compensation characteristic calculation section 214 calculates a compensation frequency characteristic to compensate for the frequency characteristic of transmission loss. The compensation characteristic calculation section 214 calculates, as a compensation frequency characteristic, the frequency characteristic that achieves an approximately flat frequency characteristic by being added to the frequency characteristic of transmission loss. In one example, the compensation characteristic calculation section 214 handles the inverse characteristic of a frequency characteristic as the compensation frequency characteristic. The compensation characteristic calculation section 214 may store a calculated compensation frequency characteristic in the storage section 220.

The inverse Fourier transforming section 216 performs inverse Fourier transform on a compensation frequency characteristic calculated by the compensation characteristic calculation section 214 to generate a compensation waveform. The inverse Fourier transforming section 216 may store a generated compensation waveform in the storage section 220.

The storage section 220 is connected to the generating section 210, and stores data received from the generating section 210. Also, the storage section 220 may store data generated by the information processing apparatus 200, or intermediate data calculated in the process of generating the data, or the like. Also, the storage section 220 may supply stored data to the source of a request, responding to the request from each section within the information processing apparatus 200.

The calculation section 230 calculates the reflection characteristic to approximate a compensation waveform by a reflected wave. The calculation section 230, in one example, receives a compensation waveform from the generating section 210 or the storage section 220, and calculates the intensity of a reflected wave to be generated at a plurality of transition points of transmission path 120 according to the compensation waveform. The calculation section 230 calculates characteristic impedance (in other words, a transmission line width) of the plurality of short transmission paths 122 based on the calculated intensity of the reflected wave at each transition point.

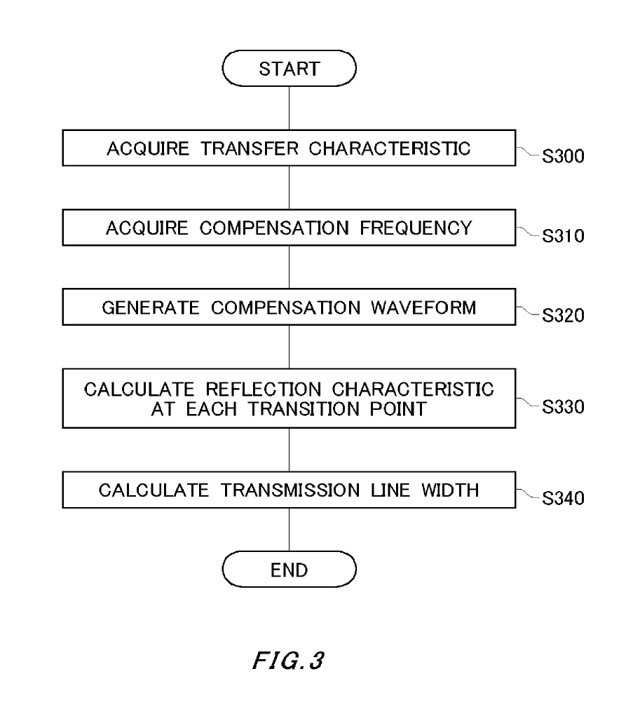

The information processing apparatus 200 according to the present embodiment as described above calculates a reflection characteristic that the compensating circuit 100 should have based on the transfer characteristic of the transmission path 20, and determines a transmission line width of each short transmission path of the plurality of short transmission paths 122. Determination of the transmission line width is explained with reference to FIG. 3.

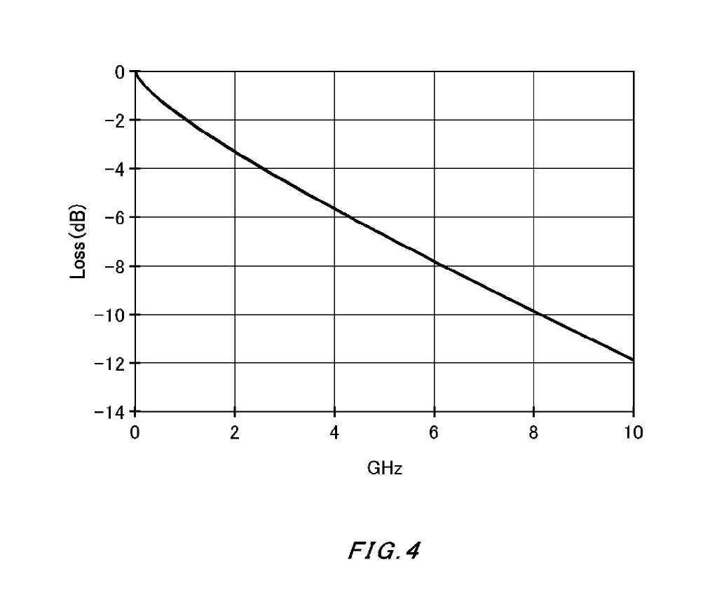

FIG. 3 illustrates an operation flow of the information processing apparatus 200 according to the present embodiment. Also, FIG. 4 illustrates one example of the attenuation characteristic of the transmission path 20 according to the present embodiment. An example in which, by performing the operation flow illustrated in FIG. 3, the information processing apparatus 200 calculates a reflection characteristic corresponding to the transmission path 20 that has the attenuation characteristic illustrated in FIG. 4, and designs the transmission path 120 provided to the compensating circuit 100 is explained.

First, the frequency characteristic acquiring section 212 acquires the transfer characteristic of the transmission path 20 (S300). The frequency characteristic acquiring section 212 acquires the attenuation characteristic illustrated in FIG. 4 as the transfer characteristic of the transmission path 20, and stores it in the storage section 220. Here, in FIG. 4, the horizontal axis indicates frequency (in the unit of GHz), and the vertical axis indicates transmission loss (in the unit of dB: decibel).

Next, the compensation characteristic calculation section 214 receives the transfer characteristic from the storage section 220 or the frequency characteristic acquiring section 212, and calculates a compensation frequency characteristic to compensate for the transfer characteristic (S310). The compensation characteristic calculation section 214, for example, converts the transmission loss of the attenuation characteristic illustrated in FIG. 4 from a value in the decibel unit to a linear value. Then, the compensation characteristic calculation section 214 calculates, as a compensation frequency characteristic, the frequency characteristic that achieves a predetermined value by being added to the transmission loss which is a linear value.

The compensation characteristic calculation section 214, in one example, calculates, as a compensation frequency characteristic, the frequency characteristic that achieves the sum with the transmission loss of 1. In other words, the compensation characteristic calculation section 214 calculates the inverse characteristic of the attenuation characteristic illustrated in FIG. 4. If a reflected wave that has such an inverse characteristic of the attenuation characteristic is superimposed on an electrical signal transmitted from the transmission path 20 to the receiving circuit 30, a waveform that has been degraded due to the transmission path 20 is ideally compensated to achieve a waveform before degradation. Accordingly, the information processing apparatus 200 designs the compensating circuit 100 so that it has the inverse characteristic of an attenuation characteristic as a reflection characteristic that the compensating circuit should have.

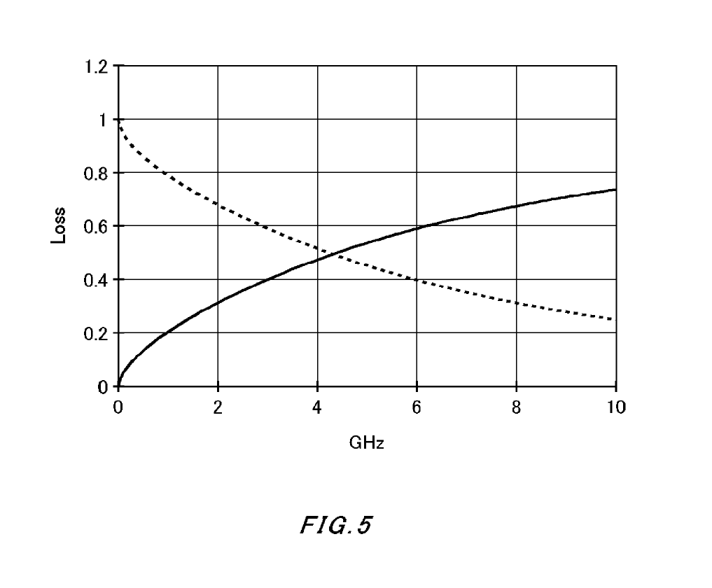

FIG. 5 illustrates one example of the inverse characteristic that is calculated by the compensation characteristic calculation section 214, and corresponds to the attenuation characteristic of the transmission path 20 according to the present embodiment. In FIG. 5, the horizontal axis indicates frequency (in the unit of GHz), and the vertical axis indicates transmission loss (linear scale). In FIG. 5, the attenuation characteristic of the transmission path 20 that is obtained by conversion of transmission loss into linear values is indicated with a dotted line. Also, the inverse characteristic corresponding to the attenuation characteristic is indicated with a solid line. It can be seen that the sum of transmission loss of the transfer characteristic of the transmission path 20, and transmission loss of the inverse characteristic at each frequency is one.

Next, the inverse Fourier transforming section 216 receives a compensation frequency characteristic from the storage section 220 or the compensation characteristic calculation section 214, and generates a compensation waveform by performing inverse Fourier transform on the compensation frequency characteristic (S320). The inverse Fourier transforming section 216 generates a temporal characteristic (impulse response) that corresponds to the compensation frequency characteristic calculated by the compensation characteristic calculation section 214.

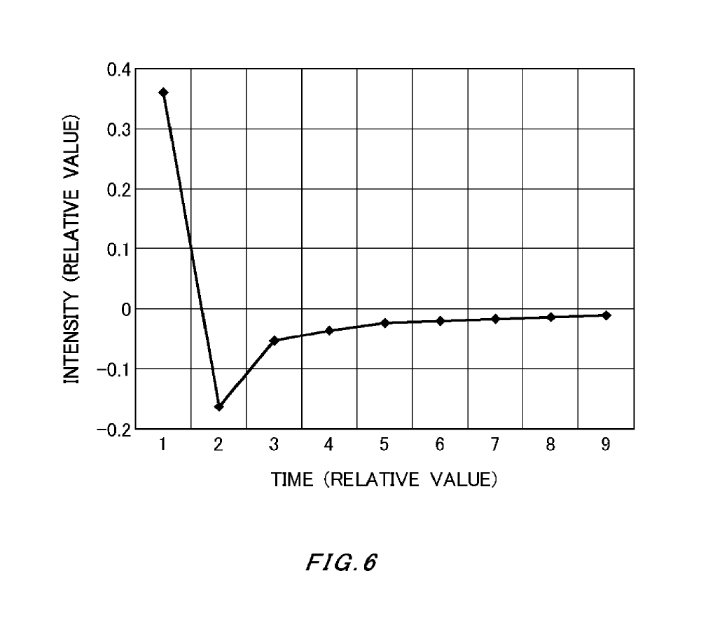

FIG. 6 illustrates one example of a compensation waveform that corresponds to the inverse characteristic of the attenuation characteristic illustrated in FIG. 5. In FIG. 6, the horizontal axis indicates time (relative values), and the vertical axis indicates amplitude (relative values). The compensation waveform illustrated in FIG. 6 corresponds to a temporal waveform of a reflection characteristic that the compensating circuit 100 should have.

Next, the calculation section 230 calculates a reflection characteristic at each transition point so that a compensation waveform is formed by a reflected wave generated at each transition point of the transmission path 120 (S330). Here, because the horizontal axis of a compensation waveform illustrated in FIG. 6 is the time axis, it can be considered that it corresponds to a time at which a reflected wave generated at each transition point of the transmission path 120 reaches the receiving circuit 30. In other words, in the process of the information processing apparatus 200 to calculate a compensation waveform, a value at each time of the compensation waveform illustrated in FIG. 6 can be allowed to correspond to each reflected wave generated at each transition point by allowing the unit of the time axis to correspond to an electrical length (50 ps in the present example) of the short transmission path 122.

For example, in FIG. 6, the information processing apparatus 200 can allow a value Γ₀ at a time t₀ to correspond to a reflected wave by the transition point X₀, and allow a value Γ₁ at a time t₁ to correspond to a reflected wave by the transition point X₁. In other words, the information processing apparatus 200 can acquire a reflection characteristic corresponding to each transition point Xₙ(n=0, 1, 2, . . . ) from the compensation waveform by allowing a value Γₙ at a time tₙ to correspond to a reflected wave by the transition point Xₙ. Accordingly, by using a difference between characteristic impedance of adjacent short transmission paths 122, the calculation section 230 can calculate characteristic impedance of each short transmission path 122 so that the reflection characteristic can be generated.

Here, assuming that characteristic impedance of two adjacent transmission paths are Zₘ and Zₘ₊₁, and a reflection coefficient at a characteristic impedance transition point is Γₘ, the relational expression of these values is as follows. (Equation 1)

Γₘ=(Zₘ−Zₘ₊₁)/(Zₘ+Zₘ₊₁)

By modifying (Equation 1), the calculation section 230 can calculate the characteristic impedance Zₘ₊₁ based on the reflection coefficient Γₘ and the characteristic impedance Zₘ as follows. (Equation 2)

Zₘ₊₁=Zₘ·(Zₘ−Γₘ)/(Zₘ+Γₘ)

In one example, when the value Γ₀ at the time t₀ of a compensation waveform corresponding to the transition point X₀ is acquired as 0.37 from FIG. 6, the calculation section 230 calculates a characteristic impedance Z₁ of a first short transmission path 122 adjacent to the input/output section 110 of the transmission path 120 as 108.7Ω. Here, the impedance of the transmitting section 10, the transmission path 20, and the input/output section 110, in one example, match with each other at the characteristic impedance Z₀ of 50Ω, and the calculation section 230 calculates Z₁ from Γ₀ and Z₀.

Similarly, when the value Γ₁ corresponding to the transition point X₁ between the first short transmission path 122 and a second short transmission path 122 is acquired as −0.16, the calculation section 230 calculates the characteristic impedance Z₂ of the second short transmission path 122 as 78.7Ω from Γ₁ and Z₁. In this manner, the calculation section 230 can calculate characteristic impedance of the plurality of short transmission paths 122 sequentially based on the compensation waveform in FIG. 6. The calculation section 230, in one example, calculates the characteristic impedance Zₙ corresponding to Γₙ shown in Table 1.

TABLE 1

| n | Γₙ | Zₙ | DELAY (ps) |
|---|---|---|---|
| 0 | 0.37 | 108.7 | 0 |
| 1 | −0.16 | 78.7 | 50 |
| 2 | −0.04 | 72.7 | 100 |
| 3 | −0.03 | 68.4 | 150 |
| 4 | −0.02 | 65.8 | 200 |
| 5 | −0.015 | 63.8 | 250 |
| 6 | −0.01 | 62.6 | 300 |
| 7 | −0.007 | 61.7 | 350 |
| 8 | −0.005 | 61.1 | 400 |

Next, the calculation section 230 calculates transmission line widths respectively based on the calculated characteristic impedance of the plurality of short transmission paths 122 (S340). The calculation section 230 calculates transmission line widths respectively according to the configuration of lines that are formed as the short transmission paths 122 such as a strip line, a micro strip line, a slot line, a coplanar waveguide, or the like.

In this manner, the information processing apparatus 200 according to the present embodiment can determine a design parameter of a transmission line that the compensating circuit 100 has, based on the transfer characteristic of the transmission path 20. FIG. 1 illustrates one example of the compensating circuit 100 determined by the information processing apparatus 200 in such a manner. FIG. 1 illustrates an example in which characteristic impedance up to n=6 has been determined.

In the above explanation, the information processing apparatus 200 according to the present embodiment determines a design parameter of the compensating circuit 100 such that a reflected wave is generated at a transition point in the compensating circuit 100 at which characteristic impedance varies, and the reflected wave is superimposed on a transmission signal, thereby compensating the transmission signal. In addition to this, the information processing apparatus 200 may determine a design parameter of the compensating circuit 100 by taking into consideration that a reflected wave generated at a transition point is reflected further at another transition point.

Also, the information processing apparatus 200 may determine a design parameter of the compensating circuit 100 by taking into consideration multiple reflection such that every time a reflected wave passes through a transition point, a part of the reflected wave passes therethrough, and the rest of it is reflected. In this case, the information processing apparatus 200 may determine a design parameter by taking into consideration only a predetermined number of times of multiple reflection. In this manner, with the information processing apparatus 200 taking into consideration of multiple reflection, a design parameter of a transmission line that the compensating circuit 100 has can be determined more accurately.

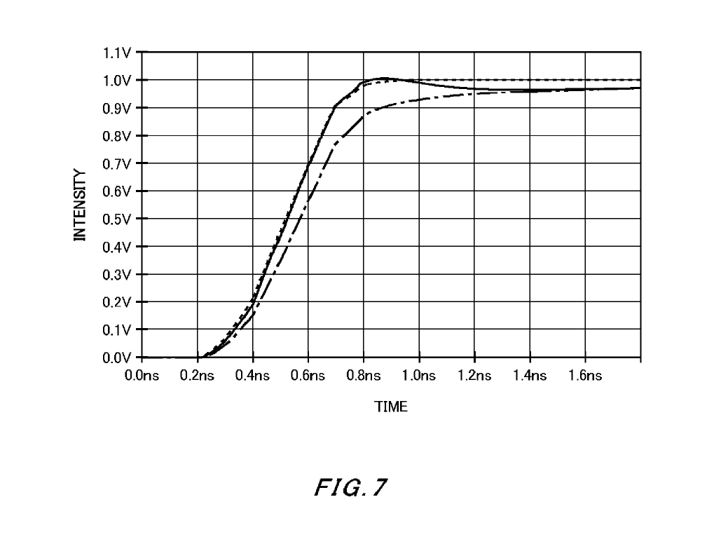

FIG. 7 illustrates one example of a waveform compensated by the compensating circuit 100 according to the present embodiment. FIG. 7 shows a result of confirmation, by a circuit simulation, of an effect of adding the compensating circuit 100 that has the short transmission paths 122 that correspond to characteristic impedance of up to n=8. In FIG. 7, the horizontal axis indicates time, and the vertical axis indicates amplitude (voltage).

In FIG. 7, a waveform indicated with a dotted line is a signal waveform transmitted by the transmitting section 10, and a waveform indicated with a dashed line is a waveform distorted due to the transmission path 20. In other words, the waveform indicated with the dashed line is a circuit simulation result of a signal waveform connected to the transmission path 20 and transferred from the transmission path 20 to the receiving circuit 30 when the compensating circuit 100 is not connected.

Also, a waveform indicated with a solid line is a signal waveform that is compensated by the compensating circuit 100. In other words, the waveform indicated with the solid line is a circuit simulation result of a signal waveform received by the receiving circuit 30 when the compensating circuit 100 is connected to the transmission terminal of the transmission path 20. It can be seen that the compensating circuit 100 can substantially compensate the waveform distorted due to the transmission path 20 so as to achieve a state of the signal waveform that is transmitted by the transmitting section 10.

In the compensating circuit 100 according to the above-described present embodiment, a waveform of longer duration can be compensated by increasing the number of the short transmission paths 122 because reflected waves that are reflected over longer elapsed time can be superimposed. For example, because the waveform indicated with the solid line in FIG. 7 is a result of superimposition of reflected waves every 50 ps in the time range of 0 to about 400 ps, a part of a distorted signal waveform up to the time point until approximately 400 ps elapses can be compensated. In other words, for example, by doubling the number of the short transmission paths 122, a part of the distorted signal waveform up to the time point until approximately 800 ps elapses among the distorted signal waveforms can be compensated.

Also, although the length of the short transmission paths 122 is explained as being 25-ps electrical length in the compensating circuit 100 according to the present embodiment, the length may instead be shorter than 25 ps. Thereby, intervals of the characteristic impedance transition points Xₙ become shorter, and the number of generated reflected waves per unit time can be increased. Thereby, because in the compensating circuit 100, the number of reflected waves to be superimposed on a signal waveform received by the receiving circuit 30 per unit time can be increased, waveforms that are distorted in a more complex manner can be compensated.

Instead of this, the length of the short transmission paths 122 may be longer than 25 ps. The compensating circuit 100 may determine in advance the length of the short transmission paths 122 according to the degree of distortion of a waveform transmitted through the transmission path 20, the rise time of a signal to be transmitted through the transmission path 20, or the like. Also, the length of each short transmission path among the plurality of short transmission paths 122 may be determined separately. In this case, the information processing apparatus 200 may determine the reflection coefficient Γₙ for the time tₙ according to the length of each short transmission path among the plurality of short transmission paths 122 in association with the reflection coefficient of the time that is closest to the time tₙ based on compensation waveforms that are arranged at temporally constant intervals.

The information processing apparatus 200 can determine a design parameter of a transmission line that the compensating circuit 100 has by performing the above-mentioned operation flow by increasing or decreasing the number of data points to be processed according to the number of the short transmission paths 122. Accordingly, the information processing apparatus 200 can design even the compensating circuit 100 that compensates a waveform distorted in a complex manner, simply and easily by approximately the same method.

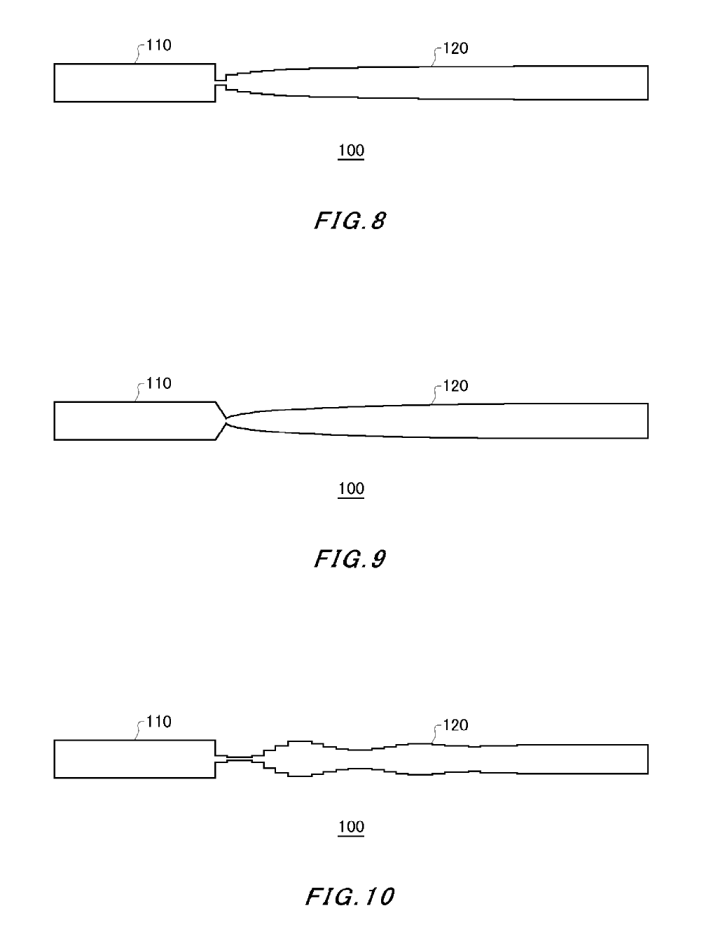

FIGS. 8 to 10 illustrate examples of the compensating circuit 100 designed by such an information processing apparatus 200. FIG. 8 illustrates a second configuration example of the compensating circuit 100 according to the present embodiment. The first configuration example of FIG. 8 is approximately the same as the configuration of the compensating circuit 100 illustrated in FIG. 1, and shows an example in which the number of the short transmission paths 122 is increased. FIG. 9 illustrates a third configuration example of the compensating circuit 100 according to the present embodiment. The second configuration example of FIG. 9 is an example in which the transmission path length of the short transmission paths 122 is made shorter, and the compensation accuracy is enhanced.

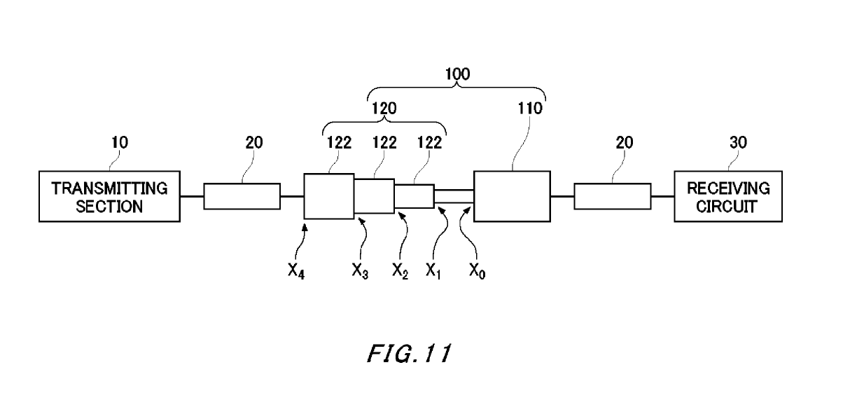

FIG. 10 illustrates a fourth configuration example of the compensating circuit 100 according to the present embodiment. The fourth configuration example of FIG. 10 illustrates the compensating circuit 100 for coping with a case where the attenuation characteristic of the transmission path 20 rapidly varies as compared with the characteristic illustrated in FIG. 3. In this manner, the information processing apparatus 200 can design the compensating circuit 100 that compensates transmission loss of the transmission path 20 according to the attenuation characteristic of the transmission path 20 in approximately the same method simply and easily.

FIG. 11 illustrates a variant of the compensating circuit 100 according to the present embodiment. In the compensating circuit 100 according to the present variant, elements that operate in approximately the same manner as those of the compensating circuit 100 according to the present embodiment illustrated in FIG. 1 are given similar reference symbols, and their explanation is omitted. The compensating circuit 100 according to the present variant compensates a signal transmitted from the transmitting section 10 before being transmitted to the receiving circuit 30, and supplies it to the receiving circuit 30.

In other words, the compensating circuit 100 is placed between the transmission terminal and the receiving terminal of the transmission path 20, and in series with the transmission path 20. The compensating circuit 100 comprises two or more transition points at which characteristic impedance is varied, and compensates a transmission waveform to be supplied to the receiving circuit 30. The compensating circuit 100 compensates a transmission waveform by superimposing, on a transmission signal transmitted from the transmission terminal to the receiving terminal of the transmission path 20, a reflected wave that is at least once reflected toward the transmission terminal side and then toward the receiving terminal side by the two or more transition points, and is transmitted to the receiving terminal, and. In other words, the compensating circuit 100 superimposes, on the transmission signal transmitted from the transmission terminal to the receiving terminal of the transmission path 20, a plurality of reflected waves that are reflected by mutually different transition points after passing through the receiving terminal.

The compensating circuit 100 may comprise three or more transition points at which characteristic impedance is varied. The compensating circuit 100 compensates a transmission waveform by superimposing, on a transmission signal transmitted from the transmission terminal to the receiving terminal of the transmission path 20, a plurality of reflected waves that are at least once reflected toward the transmission terminal side, and then reflected toward the receiving terminal side by a combination of different transition points among the plurality of transition points, and are transmitted to the receiving terminal. In this manner, the compensating circuit 100 superimposes, on a transmission signal transmitted from the transmission terminal to the receiving terminal of the transmission path 20, a plurality of reflected waves that are delayed in time mutually differently by three or more transition points.

In this manner, the compensating circuit 100 according to the present variant compensates a transmission waveform by: generating a reflection signal by allowing a part of components of a signal before reaching the receiving circuit 30 to be reflected once toward the transmission terminal side and then reflected toward the receiving terminal side; and superimposing the reflection signal. In this manner, even if the transmission waveform is distorted due to attenuation of high-frequency components, the compensating circuit 100 can compensate the distorted transmission waveform by allowing high-frequency signals that reach the receiving circuit 30 at different time ranges to be reflected (in other words, to delayed in time), and superimposing them.

Although in the compensating circuit 100 according to the present variant, the number of times of reflection increases by once as compared with the compensating circuit 100 illustrated in FIG. 1, the configuration for compensating a transmission waveform to be supplied to the receiving circuit 30 by superimposing a reflected wave is approximately the same. Accordingly, the information processing apparatus 200 illustrated in FIG. 2 can determine a design parameter of the compensating circuit 100 according to the present variant illustrated in FIG. 11 by performing approximately the same flow as the flow of FIG. 3.

It has been explained that the compensating circuit 100 according to the above-described present embodiment has the transmission path 120 that has characteristic impedance transition points, and compensates a transmission waveform by generating reflected waves at the transition points. Instead of or in addition to this, the compensating circuit 100 may have characteristic impedance transition points by using circuit elements. For example, the compensating circuit 100 has a resistor, a capacitor, and/or an inductor that vary characteristic impedance at transition points.

Also, the compensating circuit 100 may further comprise an impedance adjustment section that makes adjustable the variation in characteristic impedance at transition points. The compensating circuit 100 has, for example, a variable resistor, a variable capacitor, and/or a variable inductor as an impedance adjustment section. The impedance adjustment section may adjust characteristic impedance in combination with a switch or the like by switching a circuit constant.

Also, the compensating circuit 100 may have, as an impedance adjustment section, an opening formed at a ground electrode. Because by forming an opening at a part of a ground electrode formed to cover the transmission line, a characteristic impedance transition point of the transmission line can be formed, the impedance adjustment section can adjust the transition point and the characteristic impedance of the transition point by adjusting the placement and size of the opening.

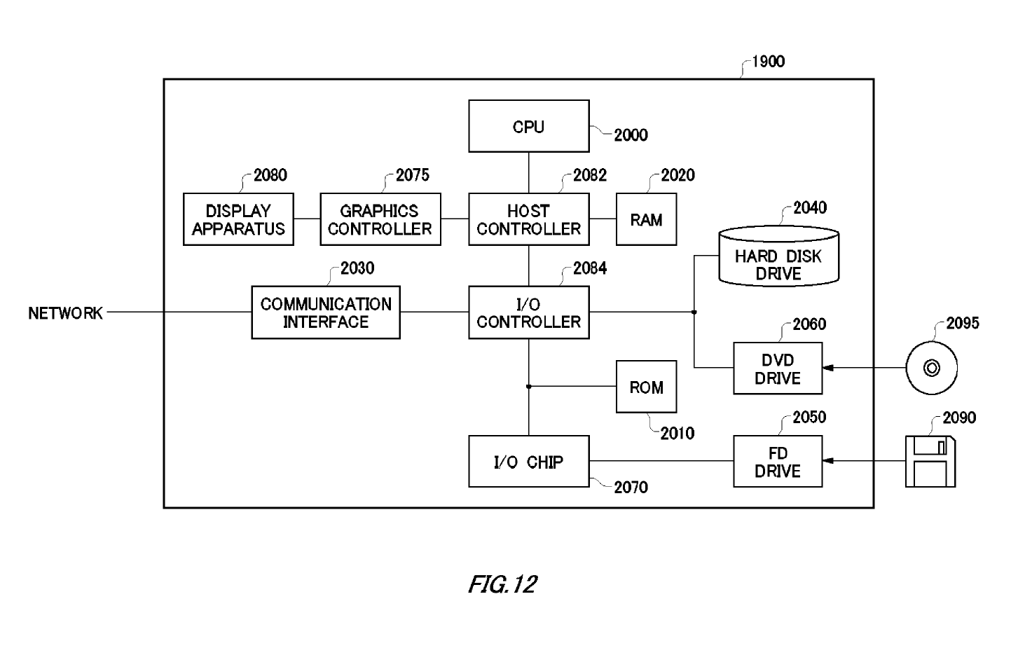

FIG. 12 illustrates one example of a hardware configuration of a computer 1900 that functions as the information processing apparatus 200 according to the present embodiment. The computer 1900 according to the present embodiment comprises: a CPU peripheral section having a CPU 2000, RAM 2020, a graphics controller 2075, and a display apparatus 2080 that are interconnected by a host controller 2082; an input/output section having a communication interface 2030, a hard disk drive 2040, and a DVD drive 2060 that are connected to the host controller 2082 by an input/output controller 2084; and a legacy input/output section having a ROM 2010, a flexible disk drive 2050, and an input/output chip 2070 that are connected to the input/output controller 2084.

The host controller 2082 connects the RAM 2020, and the CPU 2000 and the graphics controller 2075 that access the RAM 2020 at a high transfer rate. The CPU 2000 operates based on a program stored on the ROM 2010 and the RAM 2020, and controls each section. The graphics controller 2075 acquires image data that the CPU 2000 or the like generates on a frame/buffer provided within the RAM 2020, and displays the image data on the display apparatus 2080. Instead of this, the graphics controller 2075 may include therein a frame/buffer that stores image data that the CPU 2000 or the like generates.

The input/output controller 2084 connects the host controller 2082, and the communication interface 2030, the hard disk drive 2040, and the DVD drive 2060 that are relatively high-speed input/output apparatuses. The communication interface 2030 communicates with another apparatus via a network. The hard disk drive 2040 stores a program and data to be used by the CPU 2000 within the computer 1900. The DVD drive 2060 reads out a program or data from the DVD-ROM 2095, and provides the program or data to the hard disk drive 2040 via the RAM 2020.

Also, the ROM 2010, and relatively low-speed input/output apparatuses of the flexible disk drive 2050 and the input/output chip 2070 are connected to the input/output controller 2084. The ROM 2010 stores a boot program to be run at the time when the computer 1900 starts up, and/or a program that depends on hardware of the computer 1900 or the like are stored. The flexible disk drive 2050 reads out a program or data from the flexible disk 2090, and provides the program or data to the hard disk drive 2040 via the RAM 2020. The input/output chip 2070 connects the flexible disk drive 2050 to the input/output controller 2084, and connects various types of input/output apparatuses to the input/output controller 2084 for example via a parallel port, a serial port, a keyboard port, a mouse port, or the like.

A program provided to the hard disk drive 2040 via the RAM 2020 is provided by a user by being stored on a recording medium such as the flexible disk 2090, the DVD-ROM 2095, or an IC card. The program is read out from the recording medium, installed in the hard disk drive 2040 within the computer 1900 via the RAM 2020, and run at the CPU 2000.

The program is installed in the computer 1900, and allows the computer 1900 to function as the generating section 210, the frequency characteristic acquiring section 212, the compensation characteristic calculation section 214, the inverse Fourier transforming section 216, the storage section 220 and the calculation section 230.

Information processing described in the program, by being read out by the computer 1900, functions as the generating section 210, the frequency characteristic acquiring section 212, the compensation characteristic calculation section 214, the inverse Fourier transforming section 216, the storage section 220, and the calculation section 230 that are a specific means achieved by software and the above-described various hardware resources in collaboration. Then, by realizing, with this specific means, operations or processing on information according to the intended use of the computer 1900 according to the present embodiment, a special information processing apparatus 200 according to the intended use is constructed.

In one example, when performing communication between the computer 1900 and an external apparatus or the like, the CPU 2000 performs a communication program loaded onto the RAM 2020, and based on processing contents described in the communication program, instructs the communication interface 2030 to perform communication processing. Under control of the CPU 2000, the communication interface 2030 reads out transmission data stored in a transmission buffer area and the like provided on a storage device such as the RAM 2020, the hard disk drive 2040, the flexible disk 2090, or the DVD-ROM 2095, and transmits the transmission data to a network, or writes reception data received from a network in a reception buffer area or the like provided on a storage device. In this manner, the communication interface 2030 may transfer transmission/reception data with a storage device in a DMA (direct memory access) scheme, or instead of this, the CPU 2000 may transfer transmission/reception data by reading out data from a storage device or the communication interface 2030 which is a transfer source, and writing the data into the communication interface 2030 or a storage device which is a transfer destination.

Also, the CPU 2000 allows all of or necessary portions of files, databases, or the like stored on an external storage device such as the hard disk drive 2040, the DVD drive 2060 (the DVD-ROM 2095), or the flexible disk drive 2050 (the flexible disk 2090) to be read into the RAM 2020 by DMA transfer or the like, and performs various types of processing on data on the RAM 2020. Then, the CPU 2000 writes the processed data in the external storage device by DMA transfer or the like. Because in such processing, the RAM 2020 can be regarded as retaining contents of the external storage device temporarily, the RAM 2020, the external storage device, and the like are collectively called a memory, a storage section, a storage device, or the like in the present embodiment. Various types of information such as various types of programs, data, tables, databases, and the like in the present embodiment are stored on such a storage device, and serve as subjects of information processing. Note that the CPU 2000 may retain a part of the RAM 2020 in a cache memory, and write in and read from the cache memory. Because even in such an embodiment, the cache memory serves as a part of the function of the RAM 2020, the cache memory is assumed to be included in the RAM 2020, the memory, and/or the storage device in the present embodiment unless they are distinguished.

Also, the CPU 2000 performs, on data read out from the RAM 2020, various types of processing including various types of operations, processing on information, condition judgment, search and replacement of information, or the like described in the present embodiment that are specified by a sequence of instructions of the program, and write the data back to the RAM 2020. For example, when performing condition judgment, the CPU 2000 judges whether various types of variables indicated in the present embodiment meet a condition such as being larger than, smaller than, equal to or larger than, equal to or smaller than, or equal to other variable or constants, and when the condition is met (or when it is not met), the process branches to a different sequence of instructions, or a subroutine is invoked.

Also, the CPU 2000 may search information stored in a file, a database, or the like within a storage device. For example, when a plurality of entries in which an attribute value of a second attribute is respectively associated with an attribute value of a first attribute is stored on a storage device, the CPU 2000 searches, from among the plurality of entries stored on the storage device, for an entry whose attribute value of the first attribute matches a specified condition, and reads out the attribute value of the second attribute stored in the entry, thereby obtaining the attribute value of the second attribute associated with the first attribute that meets a predetermined condition.

The above-mentioned program or module may be stored on an external recording medium. The recording medium used may be, other than the flexible disk 2090 and the DVD-ROM 2095, an optical recording medium such as a DVD, Blue-ray (registered trademark), or a CD, a magneto-optical recording medium such as an MO, a tape medium, a semiconductor memory such as an IC card, or the like. Also, a storage device such as a hard disk or a RAM provided to a server system connected to a dedicated communication network or the Internet may be used as a recording medium, and a program may be provided to the computer 1900 via the network.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A compensating circuit that compensates for loss of a transmission signal that is connected to a transmission path and transmitted through the transmission path, the compensating circuit comprising:
a plurality of transition points at which characteristic impedance is varied, wherein
the compensating circuit shapes a waveform of the transmission signal by superimposing, on the transmission signal, a plurality of reflected waves that are generated by the plurality of transition points and have mutually different transmission time.

2. The compensating circuit according to claim 1, wherein
the compensating circuit comprises three or more transition points at which characteristic impedance is varied and that are placed between a transmission terminal and a receiving terminal of the transmission path and in series with the transmission path, and
the compensating circuit superimposes, on a transmission signal transmitted from the transmission terminal to the receiving terminal of the transmission path, the plurality of reflected waves that are at least once reflected toward the transmission terminal side, and then reflected toward the receiving terminal side by a combination of different transition points among the plurality of transition points, and are transmitted to the receiving terminal.

3. The compensating circuit according to claim 1, wherein
the compensating circuit is connected to a receiving terminal side of the transmission path, and superimposes, on a transmission signal transmitted from a transmission terminal of the transmission path to the receiving terminal of the transmission path, the plurality of reflected waves that are reflected by mutually different transition points among the plurality of transition points after passing through the receiving terminal, and are transmitted to the receiving terminal.

4. The compensating circuit according to claim 2, wherein the compensating circuit comprises the transition point at each end of a plurality of sections with a predetermined length.

5. The compensating circuit according to claim 4, wherein the compensating circuit has, at each of the plurality of sections, a line width in accordance with corresponding characteristic impedance.

6. The compensating circuit according to claim 1, further comprising an impedance adjustment section that makes variation in characteristic impedance at the transition point adjustable.

7. A compensating circuit that compensates for loss of a transmission signal that is connected to a transmission path and transmitted through the transmission path, the compensating circuit comprising:
at least one transition point at which characteristic impedance is varied, wherein
the compensating circuit compensates for loss of the transmission signal by superimposing a reflected wave generated at the transition point on the transmission signal.

8. The compensating circuit according to claim 7, wherein
the compensating circuit comprises two or more transition points at which characteristic impedance is varied and that are placed between a transmission terminal and a receiving terminal of the transmission path and in series with the transmission path, and
the compensating circuit superimposes, on a transmission signal transmitted from the transmission terminal to the receiving terminal of the transmission path, a reflected wave that is at least once reflected toward the transmission terminal side, and then reflected toward the receiving terminal side by the two or more transition points, and is transmitted to the receiving terminal.

9. An information processing apparatus that calculates a reflection characteristic that the compensating circuit according to claim 1 should have, the information processing apparatus comprising:
a generating section that generates a compensation waveform to compensate for loss due to the transmission path; and
a calculation section that calculates the reflection characteristic to approximate the compensation waveform by the reflected wave.

10. The information processing apparatus according to claim 9, wherein
the generating section has:
a frequency characteristic acquiring section that acquires a transfer characteristic of the transmission path in a frequency domain;
a compensation characteristic calculation section that calculates a compensation frequency characteristic to compensate for a frequency characteristic of the transmission path; and
an inverse Fourier transforming section that performs inverse Fourier transform on the compensation frequency characteristic and generates a compensation waveform.

11. The information processing apparatus according to claim 10, wherein the compensation characteristic calculation section handles an inverse characteristic of the frequency characteristic as the compensation frequency characteristic.

12. A compensation method for compensating for loss of a transmission signal that is: connected to a transmission path provided with a plurality of transition points at which characteristic impedance is varied; and transmitted through the transmission path, the method comprising:
shaping a waveform of the transmission signal by superimposing, on the transmission signal, a plurality of reflected waves that are generated by the plurality of transition points and have mutually different transmission time.

13. A computer readable storage medium having stored thereon a program that allows a computer to function as the information processing apparatus according to claim 9.
